(19) United States
(12) Patent Application Publication
(10) Pub. No.: US 2013/0120901 A1
(43) Pub. Date: May 16, 2013

(54) CAPACITOR AND METHOD FOR MANUFACTURING THE SAME

(71) Applicant: Taiyo Yuden Co., Ltd., Tokyo (JP)

(72) Inventor: Hidetoshi MASUDA, Tokyo (JP)

(73) Assignee: TAIYO YUDEN CO., LTD., Tokyo (JP)

(21) Appl. No.: 13/672,547

(22) Filed: Nov. 8, 2012

(30) Foreign Application Priority Data
Nov. 10, 2011 (JP) 2011-246045

(51) Int. Cl. H01G 4/005; H01G 4/018

(52) U.S. Cl. 361/303

(57) ABSTRACT

The capacitor includes, a pair of conductor layers opposed to each other at a predetermined distance; a dielectric layer interposed between the pair of conductor layers and composed of an oxide of valve metal; a multitude of holes formed through the dielectric layer, so as to be orthogonal to the pair of conductor layers and reach each of the pair of conductor layers; first electrodes and second electrodes formed by filling an electrode material in the holes and connected to one and the other one of the conductor layers, respectively; and insulators for electrically insulating the first electrodes from the other one of the pair of the conductor layers and the second electrodes from the one of the pair of the conductor layers, wherein the holes are formed so that the size of the diameter thereof observed in a cross-section of the dielectric layer parallel to the conductor layers becomes gradually larger from a cross-sectional position at one end of the dielectric layer toward a cross-sectional position at the other end of the dielectric layer.

### CROSS-REFERENCE TO RELATED APPLICATIONS

This application is based upon and claims the benefit of priority from prior Japanese Patent Application No. 2011-246045, filed Nov. 10, 2011 titled “CAPACITOR AND METHOD FOR MANUFACTURING THE SAME” the entire contents of which are incorporated herein by reference.

### BACKGROUND OF THE INVENTION

1. Field of the Invention

The present invention relates to a capacitor and a method for manufacturing the capacitor, and particularly to an improved capacitor intended to increase the capacitance thereof and a method for manufacturing the improved capacitor.

2. Description of the Related Art

The fundamental structure of a capacitor is such that a dielectric material is held between two electrode plates. The capacitance C of the capacitor is given by the following expression (hereinafter this expression is referred to as “capacitance formula” for descriptive purposes).

$$\begin{matrix}Expression 1 & \\ C \approx \frac{ɛ A}{d} ; A ≫ {d}^{2} & ( Capacitance formula )\end{matrix}$$

In the formula, A is the area of one electrode plate, d is the distance between electrode plates, and ε is the dielectric constant of a dielectric material. From the abovementioned capacitance formula, it is understood that the capacitance C of a capacitor can be increased by increasing dielectric constant (ε) (hereinafter referred to as Countermeasure 1), decreasing the distance between electrodes (d) (hereinafter referred to as Countermeasure 2), or increasing the area (A) of each electrode plate (hereinafter referred to as Countermeasure 3). Countermeasure 1 has the disadvantage of narrowing the range of options of the dielectric material, however. In addition, Countermeasure 2 has the disadvantage of physical limitations. Yet additionally, Countermeasure 3 has the disadvantage of failing to miniaturize the capacitor. Thus, every countermeasure has its own limits.

In order to overcome such limits, Japanese Patent Laid-Open No. 4493686, for example, describes, as the related art of the present invention, a capacitor having a structure in which a plurality of substantially columnar holes is formed in a dielectric layer provided between a pair of conductor layers opposed to each other at a predetermined interval, an electrode material is filled in these holes to form a first electrode and a second electrode, the first electrode is electrically connected only to one conductor layer, and the second electrode is electrically connected only to the other conductor layer.

In this related art, the dielectric layer in which the plurality of substantially columnar holes is formed can be said to have a so-called porous or perforated structure. Accordingly, the capacitor of this related art will hereinafter be referred to as “porous capacitor” for descriptive purposes. The porous capacitor can be said to be a capacitor the capacitance of which is increased by developing Countermeasure 3 (increasing the area A of each electrode plate) mentioned above.

That is, the area (A) of each electrode plate in the porous capacitor is given by A=a+b, assuming that the area of each of the pair of conductor layers is a, and the surface area of each of the first electrode and the second electrode is b. In the porous capacitor, the area (A) of each electrode plate can be increased by as much as the surface area b of each of the first electrode and the second electrode, without increasing the size of the capacitor, thereby increasing the capacitance C.

As described above, the related art makes available the superior advantage of being able to increase the capacitance C without increasing the size of the capacitor. A study made by the present inventors et al. has revealed, however, that the related art has room for improvement in terms of the connection reliability of components.

That is, since electronic components, such as capacitors, are in most cases solder-fixed to a substrate, stress arises due to the difference in thermal contraction between an electronic component and a substrate material (typically, plastics) at the time of post-soldering cooling in particular. Consequently, solder may peel off due to the stress, thus causing the problem that the stress impairs the connection reliability of electronic components. The study made by the present inventors et al. has revealed that the same problem arises also in the porous capacitor of the related art.

The abovementioned problem will be described using drawings. FIG. 7 is a structural drawing of the porous capacitor in the related art. In this figure, a porous capacitor 1 is configured in the manner that a dielectric layer 4 is interposed between a pair of conductor layers (hereinafter referred to as the first conductor layer 2 and the second conductor layer 3) opposed to each other at a predetermined distance, a multitude of holes 5 orthogonal to the first conductor layer 2 and the second conductor layer 3 and having the same diameter and a straight-line tubular form (hereinafter referred to as the straight tubular form) are formed in the dielectric layer 4, an electrode material is filled in these holes 5 to form first electrodes 6 and second electrodes 7, the first electrodes 6 are electrically connected only to one conductor layer (first conductor layer 2 here), and the second electrodes 7 are electrically connected only to the other conductor layer (second conductor layer 3 here).

FIG. 8 is a drawing of the porous capacitor mounted on a substrate in the related art. As illustrated in this figure, the porous capacitor 1 is mounted by connecting a pair of opposed external electrodes 8 formed at both ends of the porous capacitor 1 to electrodes 10 of a substrate 9 with solder 11.

FIG. 9 is a drawing used to explain the stress of the porous capacitor in the related art. This figure illustrates stress arising due to thermal contraction when the porous capacitor under a high-temperature environment is being cooled when the porous capacitor is soldered to the substrate 9. Specifically, the direction of each outline arrow 12 represents the direction of thermal contraction in the porous capacitor 1, and the length of each outline arrow 12 represents the amount of thermal contraction in the porous capacitor 1. Likewise, the direction of each outline arrow 13 represents the direction of thermal contraction in the substrate 9, and the length of each outline arrow 13 represents the amount of thermal contraction in the substrate 9. Note that the thermal contraction can occur in every direction of the porous capacitor 1. Attention is focused here, however, on thermal contraction in the direction of affecting the connection reliability of electronic components, i.e., on thermal contraction arising in the array direction of the pair of opposed external electrodes 8.

Incidentally, each outline arrow 12 and each outline arrow 13 are the same in orientation (the direction of thermal contraction) but different in length. That is, the amount of thermal contraction in the substrate 9 is larger than the amount of thermal contraction in the porous capacitor 1 (outline arrow 12<outline arrow 13). The reason for this is that the material of the substrate 9 is typically plastics and the thermal expansion coefficient thereof is larger than the thermal expansion coefficient of the porous capacitor 1.

Consequently, this difference in the amount of thermal contraction gives rise to stress in the connecting location between the porous capacitor 1 and the substrate 9 (solder 11). Solder 11 peels off in some cases due to this stress, thus causing the problem that the stress impairs the connection reliability of an electronic component (porous capacitor 1).

The present invention has been accomplished in view of this problem, and an object of the invention is to provide a capacitor intended to increase the connection reliability and a method for manufacturing the capacitor.

### SUMMARY OF THE INVENTION

A capacitor according to one embodiment of the present invention includes a pair of conductor layers opposed to each other at a predetermined distance; a dielectric layer interposed between the pair of conductor layers and composed of an oxide of valve metal; a multitude of holes formed through the dielectric layer, so as to be orthogonal to the pair of conductor layers and reach each of the pair of conductor layers; first electrodes formed by filling an electrode material in the holes and connected respectively to one of the conductor layers; second electrodes formed by filling an electrode material in the holes and connected respectively to the other one of the conductor layers; first insulators for electrically insulating the first electrodes from the other one of the conductor layers; and second insulators for electrically insulating the second electrodes from the one of the conductor layers, wherein the holes are formed so that the size of the diameter thereof observed in a cross-section of the dielectric layer parallel to the conductor layers becomes gradually larger from a cross-sectional position at one end of the dielectric layer toward a cross-sectional position at the other end of the dielectric layer.

A capacitor according to one embodiment of the present invention includes a pair of conductor layers opposed to each other at a predetermined distance; a dielectric layer interposed between the pair of conductor layers and composed of an oxide of valve metal; a multitude of holes formed through the dielectric layer, so as to be orthogonal to the pair of conductor layers and reach each of the pair of conductor layers; first electrodes formed by filling an electrode material in the holes and connected respectively to one of the conductor layers; second electrodes formed by filling an electrode material in the holes and connected respectively to the other one of the conductor layers; first insulators for electrically insulating the first electrodes from the other one of the conductor layers; and second insulators for electrically insulating the second electrodes from the one of the conductor layers, wherein the holes are formed so that the size of the diameter thereof observed in a cross-section of the dielectric layer parallel to the conductor layers is larger in a cross-sectional position at one end of the dielectric layer than in a cross-sectional position at the other end of the dielectric layer.

A capacitor according to one embodiment of the present invention includes a pair of conductor layers opposed to each other at a predetermined distance; a dielectric layer interposed between the pair of conductor layers and composed of an oxide of valve metal; a multitude of holes formed into a substantially tapered shape in a direction from one of the conductor layers to the other one of the conductor layers through the dielectric layer, so as to be orthogonal to the pair of conductor layers and respectively reach the pair of conductor layers; first electrodes formed by filling an electrode material in the holes and connected to one of the conductor layers; second electrodes formed by filling an electrode material in the holes and connected to the other one of the conductor layers; first insulators for electrically insulating the first electrodes from the other one of the conductor layers; and second insulators for electrically insulating the second electrodes from the one of the conductor layers.

According to various embodiments of the present invention, the multitude of holes are formed so that the diameter thereof, i.e., the diameter of electrodes filled in the holes, observed in a cross-section of the dielectric layer parallel to the conductor layers becomes gradually larger from a cross-sectional position at one end of the dielectric layer toward a cross-sectional position at the other end of the dielectric layer. Alternatively, the multitude of holes are formed so that the diameter thereof, i.e., the diameter of electrodes filled in the holes, observed in a cross-section of the dielectric layer parallel to the conductor layers is larger in a cross-sectional position at the other end of the dielectric layer than in a cross-sectional position at the one end of the dielectric layer. Accordingly, stress arising due to the difference in thermal expansion coefficient between the main body of the porous capacitor and the substrate and working on locations of the capacitor fixed to the substrate can be relieved, and therefore, solder peel-off can be prevented by mounting the porous capacitor, so that the other end of the dielectric layer is the side thereof to be soldered to the substrate. Thus, it is possible to provide a porous capacitor the connection reliability of which is improved.

### BRIEF DESCRIPTION OF THE DRAWINGS

FIG. 1 is a configuration diagram of a capacitor according to an embodiment.

FIG. 2 is a structural drawing of a porous capacitor 20 including external electrodes.

FIG. 3 is a drawing used to describe a method for confirming the shape of holes 24.

FIG. 4 is a mounting drawing of the porous capacitor 20 of the embodiment.

FIG. 5 is a partial conceptual drawing of a manufacturing method in the embodiment.

FIG. 6 is a drawing illustrating the porous capacitor 20 in which external electrodes are formed on one side.

FIG. 7 is a structural drawing of a porous capacitor in the related art.

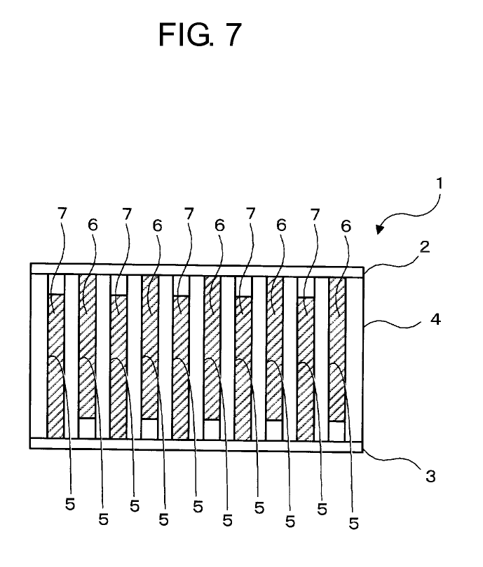

FIG. 8 is a drawing of the porous capacitor mounted on a substrate in the related art.

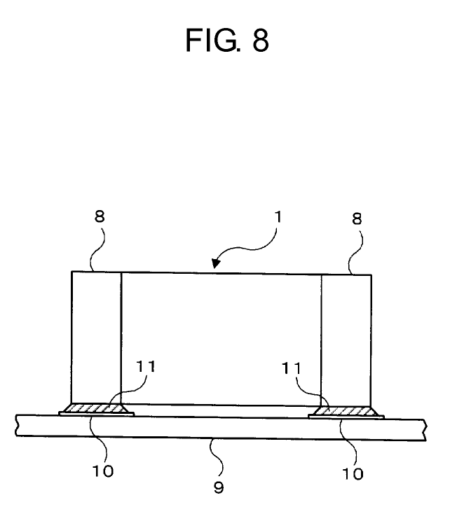

FIG. 9 is a drawing used to explain the stress of the porous capacitor in the related art.

### DETAILED DESCRIPTION OF THE PREFERRED EMBODIMENTS

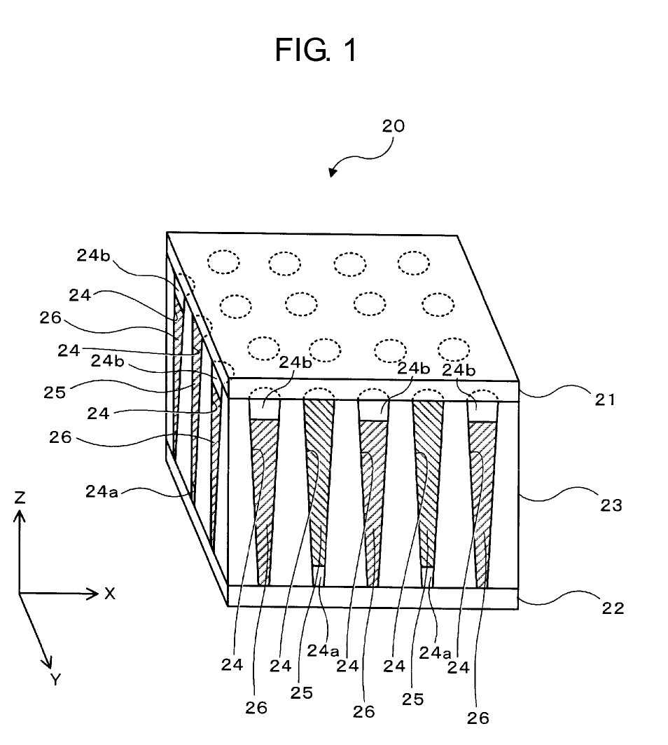

Hereinafter, embodiments of the present invention will be described while referring to the accompanying drawings. FIG. 1 is a configuration diagram of a capacitor (hereinafter referred to as “porous capacitor”) according to an embodiment. A porous capacitor 20 of the embodiment is likewise configured in the manner that a dielectric layer 23 is interposed between a pair of conductor layers (hereinafter referred to as the first conductor layer 21 and the second conductor layer 22) opposed to each other at a predetermined distance, a multitude of holes 24 orthogonal to the first conductor layer 21 and the second conductor layer 22 are formed in the dielectric layer 23, an electrode material is filled in these holes 24 to form first electrodes 25 and second electrodes 26, the first electrodes 25 are electrically connected only to one conductor layer (first conductor layer 21 here), and the second electrodes 26 are electrically connected only to the other conductor layer (second conductor layer 22 here).

Here, a definition will be given to the directions of three axes (X-, Y- and Z-axis directions) of the drawing. An X-axis denotes a direction along one side each of the first conductor layer 21 and the second conductor layer 22, a Y-axis denotes a direction along another side each of the first conductor layer 21 and the second conductor layer 22 orthogonal to the one side thereof, and a Z-axis denotes a direction in which the first conductor layer 21 and the second conductor layer 22 are opposed to each other.

Note that in FIG. 1, a portion of the hole 24 of each first electrode 25 on the side thereof not connected to the second conductor layer 22 is left over as a space 24a. Likewise, a portion of the hole 24 of each second electrode 26 on the side thereof not connected to the first conductor layer 21 is left over as a space 24b. These spaces 24a and 24b are intended to electrically connect the first electrodes 25 only to one conductor layer (first conductor layer 21 here) and the second electrodes 26 only to the other conductor layer (second conductor layer 22 here). That is, the spaces 24a and 24b function as insulators used to make such selective connections.

As will be described in detail hereafter, the holes 24 in the present embodiment illustrated in FIG. 1 are formed of a substantially tapered shape rather than a straight tubular form.

That is, the diameter of the holes 24 observed in a cross-section of the dielectric layer 23 parallel to the conductor layers (first conductor layer 21 and second conductor layer 22) formed on both sides of the dielectric layer 23 becomes gradually larger from a cross-sectional position at one end of the dielectric layer 23 (a cross-section of the dielectric layer near a portion thereof in abutment with the second conductor layer 22 in FIG. 1) toward a cross-sectional position at the other end of the dielectric layer 23 (a cross-section of the dielectric layer near a portion thereof in abutment with the first conductor layer 21 in FIG. 1). In other words, a cross-section of each hole 24 in the Z-axis direction parallel to the direction of an electrode in the hole in FIG. 1 is formed of a substantially tapered shape.

Note that the phrase “substantially tapered shape” as used herein refers to shapes in which a hole is tapered only on one side thereof, or the hole, though unevenly tapered, has a tapered shape if both ends of the hole are connected with a straight line. In addition, the phrase “substantially tapered shape ” includes shapes such as shapes in which the diameter of a hole becomes gradually smaller in a gentle, stepwise manner.

As described above, an electrode material is filled in the holes 24 to form the first electrodes 25 electrically connected only to one conductor layer (first conductor layer 21 here) and the second electrodes 26 electrically connected only to the other conductor layer (second conductor layer 22 here). These first electrodes 25 and second electrodes 26 are arranged in an alternate manner (or at random). Accordingly, these first electrodes 25 and second electrodes 26 results in the same shape as the shape of the holes 24. That is, the diameter of respective electrodes (first electrodes 25 and second electrodes 26) observed in a cross-section of the dielectric layer 23 parallel to the conductor layers (first conductor layer 21 and second conductor layer 22) formed on both sides of the dielectric layer 23 becomes gradually larger from a cross-sectional position at one end of the dielectric layer 23 (a cross-section of the dielectric layer near a portion thereof in abutment with the second conductor layer 22 in FIG. 1) toward a cross-sectional position at the other end of the dielectric layer 23 (a cross-section of the dielectric layer near a portion thereof in abutment with the first conductor layer 21 in FIG. 1). In other words, the cross-sectional shape of each first electrode 25 or second electrode 26 in the Z-axis direction in FIG. 1 is also a substantially tapered shape.

As examples of preferred materials of respective components, it is possible to use a general family of metal (Cu, Ni, Cr, Ag, Au, Pd, Fe, Sn, Pb, Pt, Ir, Rh, Ru, Al, and the like) for the first conductor layer 21 and the second conductor layer 22. For the dielectric layer 23, it is possible to use an oxide formed by anodizing valve metal (Al, Ta, Nb, Ti, Zr, Hf, Zn, W, Sb, or the like) as a base material and/or an oxide formed by anodizing an alloy containing one or more of these types of metal. For the first electrodes 25 and second electrodes 26, it is possible to use a general family of metal capable of being plated (Cu, Ni, Co, Cr, Ag, Au, Pd, Fe, Sn, Pb, Pt, and the like) or an alloy composed of one or more of these types of metal.

In the illustrated structure, a space 24a (formed by emptying part of each hole 24) is provided between each first electrode 25 and the second conductor layer 22 and a like space 24b is provided between each second electrode 26 and the first conductor layer 21, in order to electrically connect the first electrodes 25 only to one conductor layer (first conductor layer 21 here) and the second electrodes 26 only to the other conductor layer (second conductor layer 22 here). The present invention is not limited to this embodiment. What matters is that the structure should have an insulation mode capable of cutting off (insulating) the electrical connection between each first electrode 25 and the second conductor layer 22 and between each second electrode 26 and the first conductor layer 21. For example, the structure may have an insulation mode of filling the spaces 24a and 24b with an optional insulator (including a dielectric material).

As dimensional examples of the respective components of the porous capacitor 20, the distance between the first conductor layer 21 and the second conductor layer 22 (also the thickness of the dielectric layer 23) is several 100 nm to several 100 μm, and the thickness of each of the first conductor layer 21 and the second conductor layer 22 is several 10 nm to several μm. In addition, the first electrodes 25 and the second electrodes 26 are approximately 30 nm in minimum diameter, approximately several 50 nm in maximum diameter, and 100 nm to several 100 μm in length. The distance between adjacent electrodes is approximately several 10 nm to several 100 nm. The thickness of each of the spaces 24a and 24b in the Z-axis direction is approximately several 10 nm to several 10 μm.

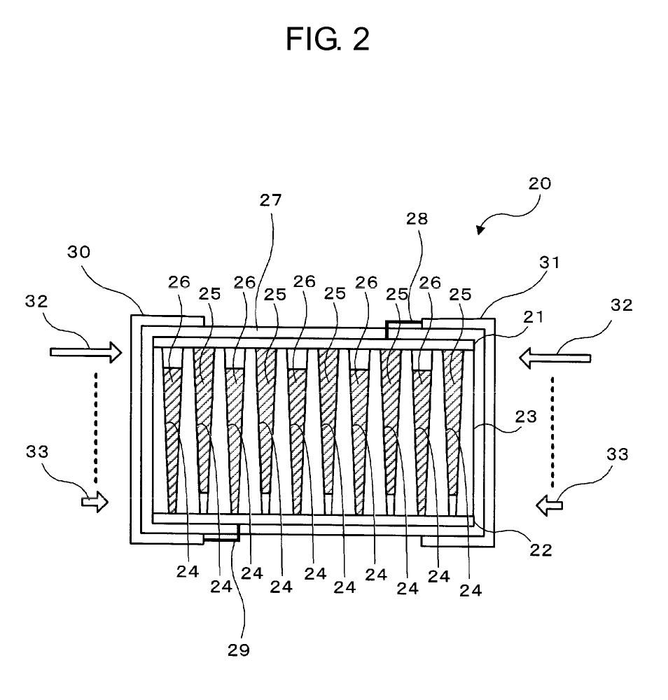

FIG. 2 is a structural drawing of the porous capacitor 20 including external electrodes. As illustrated in this figure, the porous capacitor 20 as a whole is covered with an insulating film 27 (exterior protection material). In addition, lead wires 28 and 29 drawn out from openings provided in predetermined positions of this insulating film 27 are connected to external electrodes 30 and 31 formed at both ends of the porous capacitor 20. For the insulating film 27, it is possible to use, for example, SiO₂, SiN, resin, or a metal oxide. The thickness of the insulating film 27 can be approximately several 10 nm to several 10 μm.

Next, the shape in which the diameter of the holes 24 observed in a cross-section of the dielectric layer 23 parallel to the conductor layers (first conductor layer 21 and second conductor layer 22) formed on both sides of the dielectric layer 23 becomes gradually larger from a cross-sectional position at one end of the dielectric layer 23 toward a cross-sectional position at the other end of the dielectric layer 23 can be confirmed by such a method as described below.

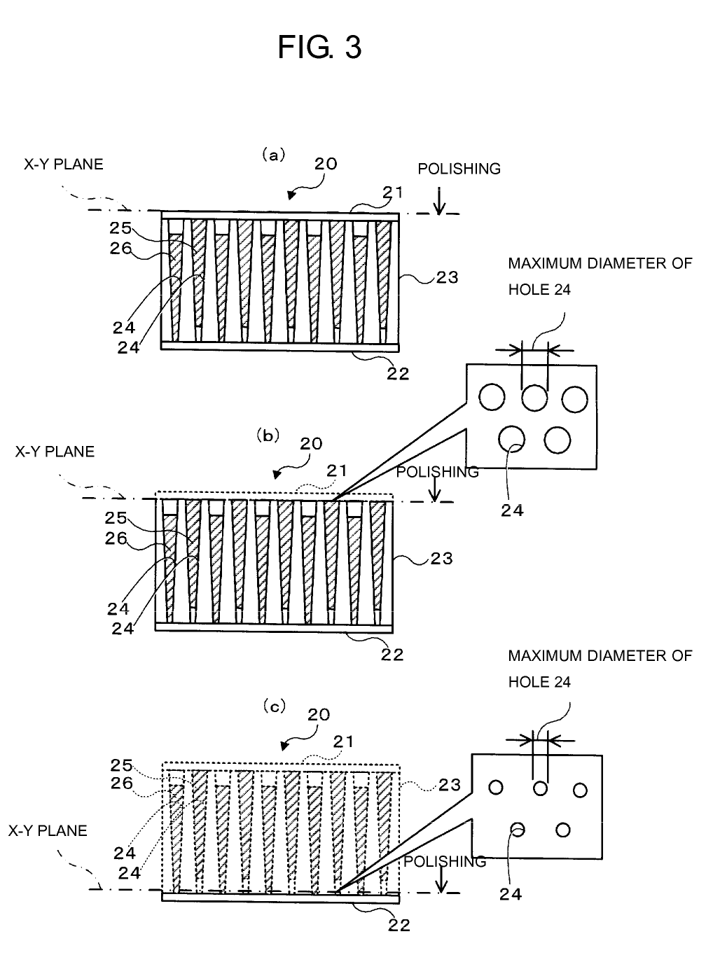

FIG. 3 is a drawing used to describe a method for confirming the shape of the holes 24. First, as illustrated in FIG. 3A, the thickness of the first conductor layer 21 gradually decreases if the porous capacitor 20 of FIG. 1 is mechanically polished in a plane along an X-Y plane. At a certain point in time, the thickness of the first conductor layer 21 reaches zero and a surface of the dielectric layer 23 becomes exposed, as illustrated in FIG. 3B. At this point in time, polishing is stopped temporarily, and a cross-section of the dielectric layer 23 at this moment is specified as a cross-sectional position at one end of the dielectric layer 23. Then, the maximum diameter of the holes 24 is measured using a scanning electron microscope or the like by looking down upon the cross-section from above a point on the Z-axis. Care should be taken here that the holes 24 are not formed of an elliptical shape distorted in the same direction. If the holes 24 have such a shape, the cross-section may be inclined, and therefore, polishing is once again performed to make adjustments. A measurement is made of n holes in plane with one another (n should be defined as, for example, n=300, so as to statistically represent the surface under measurement). The maximum diameter of holes 24 deformed in shape or extraordinarily large in size obviously due to a special cause, such as faulty polishing, are excluded from the values thus measured.

After the first measurement (FIG. 3B) described above, the same sample is further polished from the same direction in the same way as described above. Then, as illustrated in FIG. 3C, polishing is stopped immediately before the second conductor layer 22 is reached and at the moment the abovementioned holes 24 become exposed on the entire surface being polished. A cross-section of the dielectric layer 23 at this moment is specified as a cross-sectional position at the other end of the dielectric layer 23. Then, the maximum diameter of the holes 24 is measured using a scanning electron microscope or the like by looking down upon the cross-section from above a point on the Z-axis. The number of measured locations is defined as n=300, and this measurement is specified as the second measurement. What should be careful about at this time is the same as mentioned in the first measurement. Although it is desirable to measure holes 24 near locations where the holes 24 measured first are present, these holes need not necessarily be in a one-to-one relationship. In addition, mechanical polishing may be initiated on the second conductor layer 22 side.

Subsequently, calculations are made of the average values of respective items of measured data thus obtained. By calculating the difference between the first (FIG. 3B) and second (FIG. 3C) measured values or the absolute value of the difference, it is possible to confirm that the diameter of the holes 24 becomes larger toward one direction of the dielectric layer 23. If the diameter of the holes 24 becomes smaller toward one direction of the dielectric layer 23, this should be regarded as the case in which a cross-sectional observation was performed by initiating polishing from a direction opposite to the direction of the abovementioned case.

The number of samples of the porous capacitor 20 for which these measurements are conducted may be, for example, five or so. By making evaluations after excluding the maximum and minimum values from five data items obtained after measurement and thus limiting the amount of data to three data items, it is possible to preclude special causal factors, such as measuring defective samples by mistake.

The table below shows a specific example of data obtained.

TABLE 1

| | | Sample No. of porous capacitor | | |
|---|---|---|---|---|
| | | No1 | No2 | No3 |
| Average diameter | One end of | 28.3 nm | 30.6 nm | 30.9 nm |
| of holes 24 | dielectric layer 23 | | | |
| | Other end of | 48.0 nm | 49.2 nm | 50.2 nm |
| | dielectric layer 23 | | | |

| | | | |
|---|---|---|---|
| Average diametral increment in hole 24 | 19.7 nm | 19.0 nm | 19.3 nm |

If it is difficult to determine whether or not a hole 24 has become larger, a standard deviation or a variance value should be calculated to make determinations with regard to the presence/absence of any average value differences by means of significant difference test (risk rate of 5%) or the like.

Note that the porous capacitor 20 may be cut along a plane parallel to the Z-axis in FIG. 1, and holes 24 present in the plane of section may be observed from above the cross-section in the vertical direction thereof by using a scanning electron microscope or the like. From the microscope image, it is possible to visually confirm that the holes 24 or electrodes (first electrodes 25 and second electrodes 26) filled therein are formed of a substantially tapered shape.

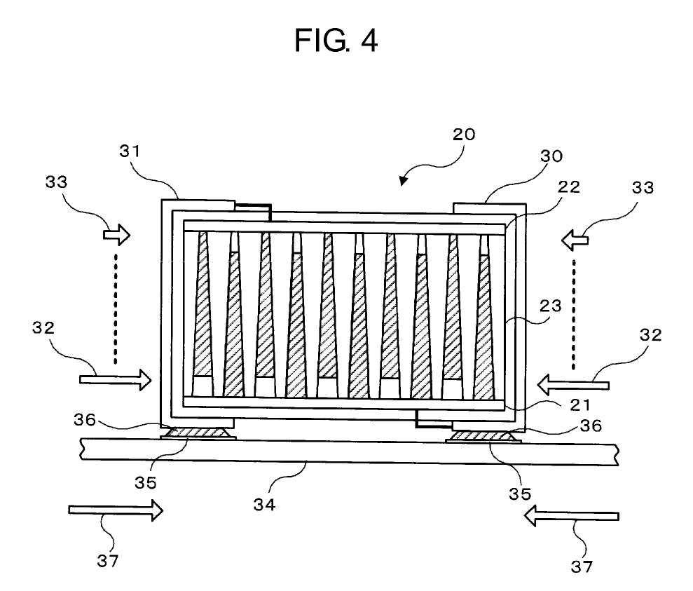

Thereafter, external electrodes (see the external electrodes 30 and 31 in FIG. 2) are usually formed in the porous capacitor 20 of the embodiment, so as to cover the opposed two principal surfaces thereof Then, the porous capacitor 20 is solder-mounted on a substrate (see the substrate 34 in FIG. 4) to be put in practical use. At the time of such practical use, connection reliability can be improved for the following reason. For example, Al₂O₃ having a thermal expansion coefficient of 4 ppm/K is used as the material of the dielectric layer 23. In addition, Ni having a thermal expansion coefficient of 13 ppm/K is used as the material of electrodes (first electrodes 25 and second electrodes 26). Yet additionally, plastics having a thermal expansion coefficient of several 10 to several 100 ppm/K is used as the material of the substrate 34. Here, the term “ppm” refers to a unit (parts per million) representing a ratio in fractions of a millionth.

In FIG. 2, Ni electrodes (first electrodes 25 and second electrodes 26), for example, are filled in the holes 24 formed in the porous capacitor 20. In the porous capacitor 20, these Ni electrodes (first electrodes 25 and second electrodes 26) account for the largest volume at the other end (on the first conductor layer 21 side) and the smallest volume at one end (on the second conductor layer 22 side). If the dielectric layer 23 is composed of Al₂O₃, the Ni electrodes (first electrodes 25 and second electrodes 26) which are metal as described above are larger in thermal expansion coefficient than the dielectric layer 23. Consequently, the amount of thermal contraction arising in the porous capacitor 20 when the porous capacitor 20 under a high-temperature environment is cooled down is maximum at one end (on the first conductor layer 21 side) and minimum at the other end (on the second conductor layer 22 side). This condition is illustrated in FIG. 2 by using outline arrows 32 and 33. That is, the outline arrow 32 shows a large amount of thermal contraction at one end (on the first conductor layer 21 side), and the outline arrow 33 shows a small amount of thermal contraction at the other end (on the second conductor layer 22 side).

FIG. 4 is a mounting drawing of the porous capacitor 20 of the embodiment. As illustrated in this figure, a surface of the porous capacitor 20 of the embodiment larger in the amount of thermal contraction than the other surface is used as the side for mounting the porous capacitor 20 on the substrate 34. That is, when the porous capacitor 20 of FIG. 2 is mounted on the substrate 34, the external electrodes 30 and 31 at both ends of the porous capacitor 20 connected to electrodes 35 of the substrate 34 with solder 36, with the porous capacitor 20 turned “upside down.”

Now, consideration will be given to the amount of thermal contraction in the direction of a pair of external electrodes 30 and 31 when the solder 36 is firmly fixed at high temperature and is then cooled down in a case where the porous capacitor 20 is mounted on the substrate 34 as illustrated in FIG. 4. The amount of thermal contraction of the substrate 34 composed of plastics is largest (see an outline arrow 37), and therefore, stress arises in a direction in which the substrate 34 contracts with respect to the porous capacitor 20. Since a volume occupied by the Ni electrodes in the porous capacitor 20 is large on the side thereof for mounting on the substrate 34, however, as shown by outline arrows 32 and 33, the amount of thermal contraction on the side for mounting on the substrate 34 is large (outline arrow 32>outline arrow 33).

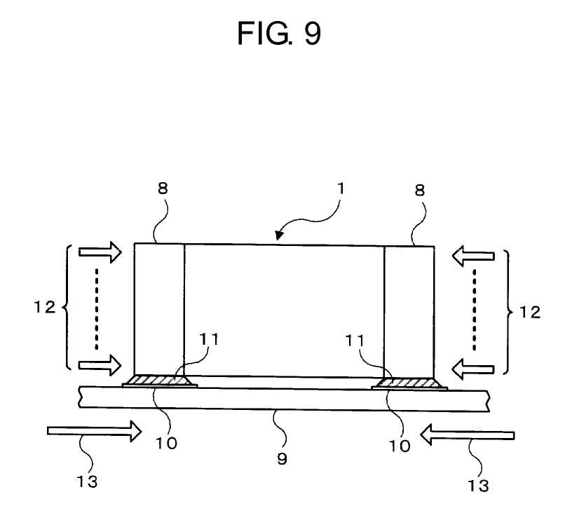

Accordingly, as is evident by comparison between FIG. 4 and FIG. 9, a difference of the porous capacitor 20 in the amount of thermal contraction from the substrate 34 which is a mounting counterpart is smaller, compared with a conventional porous capacitor 1, on the side of the porous capacitor 20 for mounting on the substrate 34. Thus, stress arising in the solder 36 for firmly fixing the capacitor and the substrate to each other is small. Consequently, the porous capacitor 20 of the present embodiment can make improvements against a connection failure resulting from the peel-off of the solder 36 or the like caused by stress due to a difference in the amount of thermal contraction, thereby improving connection reliability.

One of main configurational points in the embodiment can therefore be said to lie in the fact that the diameter of the holes 24 exposed on a cross-section parallel to the conductor layers (first conductor layer 21 and second conductor layer 22) formed on both sides of the dielectric layer 23 becomes larger from a cross-sectional position at one end of the dielectric layer 23 toward a cross-sectional position at the other end of the dielectric layer 23. With this main configurational point, it is possible to make the amount of thermal contraction in the cross-sectional position at the other end of the dielectric layer 23 larger than the amount of thermal contraction in the cross-sectional position at one end of the dielectric layer 23. Accordingly, by using a surface of the porous capacitor 20 larger in the amount of thermal contraction as the side of the porous capacitor 20 for mounting on the substrate 34, it is possible to reduce a difference of the porous capacitor 20 in the amount of thermal contraction from the substrate 34 and relieve stress on locations of connection (solder 36) to the substrate 34, thereby eliminating connection failures. Note that according to the above-described main configurational point, the diameter of the holes 24 becomes larger from a cross-sectional position at one end of the dielectric layer 23 toward a cross-sectional position at the other end of the dielectric layer 23. Alternatively, however, an embodiment may be adopted in which, for example, the diameter of the holes 24 is larger in the cross-sectional position at the other end of the dielectric layer 23 than in the cross-sectional position at one end of the dielectric layer 23, i.e., the diameter of the holes 24 varies in a stepwise manner.

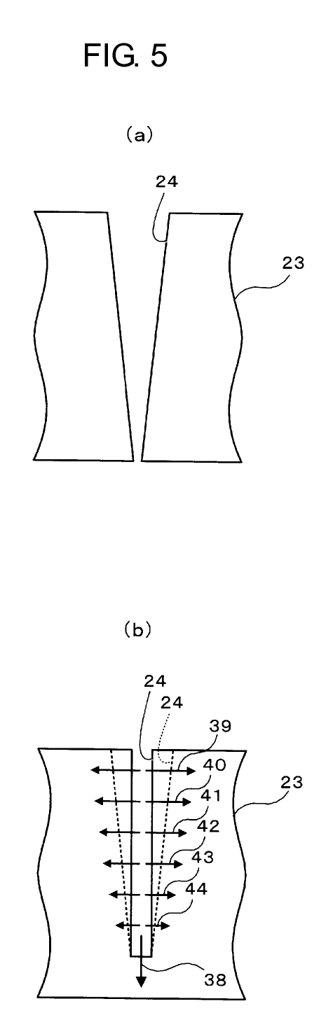

In general, Embodiment 1 of Japanese Patent No. 4493686, and the like are known as methods for manufacturing a porous capacitor. Hereinafter, a description will be given of a manufacturing method intended to realize a configuration which is a main point of the present invention. FIG. 5A is a partial conceptual drawing illustrating a manufacturing method when holes are formed in an aluminum base substance or the like by means of anodization. The shape in which the diameter of the holes 24 exposed on a cross-section parallel to the conductor layers (first conductor layer 21 and second conductor layer 22) formed on both sides of the dielectric layer 23 becomes larger from a cross-sectional position at one end of the dielectric layer 23 toward a cross-sectional position at the other end of the dielectric layer 23, when viewed from a different cross-sectional direction, changes to such a shape as illustrated in FIG. 5A. That is, as illustrated in FIG. 5A, the shape of the holes 24, if viewed from a cross-section of the holes 24 in the depth direction thereof, can be said to be a tapered shape. In order to form the holes 24 into such a shape, anodization conditions should be controlled at the time of forming the holes 24 in the dielectric layer 23.

For example, a reaction rate becomes faster as a whole, if anodization is performed by setting a solution to a high temperature as anodization conditions. On the other hand, the solution fails to circulate in time for the speeded-up reaction of anodization. This tendency becomes more prominent at a deeper position of the holes 24, and the process of contact between the solution and the aluminum base substance is subject to reaction rate controlling. Thus, the cross-sections of each hole 24 in the depth direction thereof take a tapered shape. Specifically, the anodization conditions should be specified as, for example, 0.1 mol/l of oxalic acid, a temperature of 30° C., a voltage of 40 V, and a solution immersion time of 12 hours.

FIG. 5B is a partial conceptual drawing illustrating another manufacturing method in an embodiment of hole formation by anodization. The holes 24 are temporarily formed into a taperless state (state shown by a solid line) as viewed from a cross-section of the holes 24 in the depth direction thereof Thereafter, the porous capacitor is immersed in a solution for dissolving Al₂O₃ present on surfaces of each hole. In this case, the circulation of the solution is subject to reaction rate controlling, and therefore, dissolution progresses faster in portions of the holes 24 closer to the inlets thereof (see arrows 39 to 44). In this way, the holes 24 can be formed into a tapered shape. Specifically, in order to form the holes 24 into a taperless state, the anodization conditions should first be specified as 0.3 mol/1 of oxalic acid, a temperature of 10° C., a voltage of 40 V, and a solution immersion time of 24 hours. Then, the porous capacitor should be immersed in, for example, a 5 wt % phosphoric acid solution to dissolve the Al₂O₃, so that dissolution progress faster in portions of the holes 24 closer to the inlets thereof

In this way, the cross-sectional shape of the holes 24 in the depth direction thereof can be tapered by controlling the anodization conditions and the like at the time of forming the holes 24 in the dielectric layer 23. That is, the diameter of the holes 24 observed in a cross-section of the dielectric layer 23 parallel to the conductor layers (first conductor layer 21 and second conductor layer 22) formed on both sides of the dielectric layer 23 can be made to become gradually larger from a cross-sectional position at one end of the dielectric layer 23 (a cross-section of the dielectric layer near a portion thereof in abutment with the second conductor layer 22 in FIG. 1) toward a cross-sectional position at the other end of the dielectric layer 23 (a cross-section of the dielectric layer near a portion thereof in abutment with the first conductor layer 21 in FIG. 1).

Note that as described above, the shape of the holes 24 is not limited to a cross-sectionally tapered shape. The shape may be a substantially tapered shape or a shape similar to a tapered shape that can be regarded as being tapered. The phrase “substantially tapered shape” includes shapes in which each hole, when viewed from a cross-section thereof, is tapered only on one side. Possible shapes similar to this shape include a shape in which the diameter becomes gradually smaller in a stepwise manner. An appropriate shape should be selected in consideration of the ease of manufacture and the like.

Methods for determining the orientation of the component under discussion (porous capacitor 20), so that the first conductor layer 21 side in FIG. 1 corresponds to the substrate 34 side, when mounting the porous capacitor 20 on the substrate 34 include such methods as described below.

For example, the shape of the lead wire 28 on the principal surface of the first conductor layer 21 may be differentiated from the shape of the lead wire 29 on a surface opposite to the principal surface after the external electrodes 30 and 31 are formed. Then, this difference between the lead wires 28 and 29 should be recognized at the time of mounting to determine the direction of mounting on a substrate. Alternatively, when the first conductor layer 21 and the second conductor layer 22 are formed, sputtering conditions may be varied, for example, to differentiate the reflectances of the first conductor layer 21 and the second conductor layer 22 from each other. By this method, it is possible to fix the mounting direction by means of sensor-based automatic recognition, and then mount the capacitor on the substrate 34 with a correct orientation.

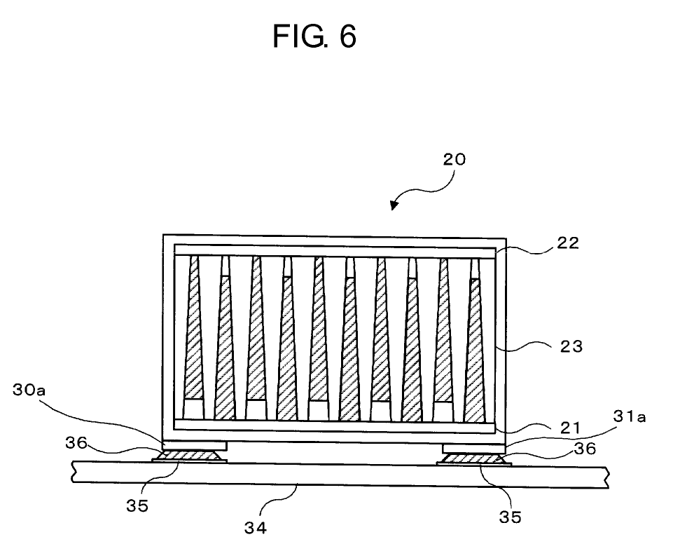

Yet alternatively, for example, external electrodes may be formed only on the side for mounting on the substrate 34. FIG. 6 is a drawing illustrating a porous capacitor 20 in which external electrodes are formed on one side of the capacitor. As illustrated in this figure, external electrodes 30a and 31a are formed only on one side (on the first conductor layer 21 side) of the porous capacitor 20. As described above, this one side is the side for mounting on the substrate 34. Accordingly, no confusion is caused, in a step of mounting the porous capacitor 20 on the substrate 34, as to which surface should be used as the mounting side. The external electrodes 30a and 31a located on one side as illustrated in FIG. 6 can be formed by a commonly-known method. That is, the external electrodes 30a and 31a can be formed by dipping one end of the porous capacitor in paste for external electrodes, attaching the paste to the capacitor, and drying and baking the paste.

The present invention is suitable for a capacitor intended to increase the capacitance thereof and a method for manufacturing the capacitor. The present invention, if applied to a porous capacitor in particular, can improve the reliability of connection to a substrate and is, therefore, extremely effective.

What is claimed is:

1. A capacitor comprising:
a pair of conductor layers opposed to each other at a predetermined distance;
a dielectric layer interposed between the pair of conductor layers and composed of an oxide of valve metal;
a multitude of holes formed through the dielectric layer, so as to be orthogonal to the pair of conductor layers and reach each of the pair of conductor layers;
first electrodes formed by filling an electrode material in the holes and connected respectively to one of the conductor layers;
second electrodes formed by filling an electrode material in the holes and connected respectively to the other one of the conductor layers;
first insulators for electrically insulating the first electrodes from the other one of the conductor layers; and
second insulators for electrically insulating the second electrodes from the one of the conductor layers,
wherein the holes are formed so that the size of the diameter thereof observed in a cross-section of the dielectric layer parallel to the conductor layers becomes gradually larger from a cross-sectional position at one end of the dielectric layer toward a cross-sectional position at the other end of the dielectric layer.

2. A capacitor comprising:
a pair of conductor layers opposed to each other at a predetermined distance;
a dielectric layer interposed between the pair of conductor layers and composed of an oxide of valve metal;
a multitude of holes formed through the dielectric layer, so as to be orthogonal to the pair of conductor layers and reach each of the pair of conductor layers;
first electrodes formed by filling an electrode material in the holes and connected respectively to one of the conductor layers;
second electrodes formed by filling an electrode material in the holes and connected respectively to the other one of the conductor layers;
first insulators for electrically insulating the first electrodes from the other one of the conductor layers; and
second insulators for electrically insulating the second electrodes from the one of the conductor layers,
wherein the holes are formed so that the size of the diameter thereof observed in a cross-section of the dielectric layer parallel to the conductor layers is larger in a cross-sectional position at one end of the dielectric layer than in a cross-sectional position at the other end of the dielectric layer.

3. A capacitor comprising:
a pair of conductor layers opposed to each other at a predetermined distance;
a dielectric layer interposed between the pair of conductor layers and composed of an oxide of valve metal;
a multitude of holes formed into a substantially tapered shape in a direction from one of the conductor layers to the other one of the conductor layers through the dielectric layer, so as to be orthogonal to the pair of conductor layers and respectively reach the pair of conductor layers;
first electrodes formed by filling an electrode material in the holes and connected to one of the conductor layers;
second electrodes formed by filling an electrode material in the holes and connected to the other one of the conductor layers;
first insulators for electrically insulating the first electrodes from the other one of the conductor layers; and
second insulators for electrically insulating the second electrodes from the one of the conductor layers.
